(19) United States
(12) Patent Application Publication
(10) Pub. No.: US 2005/0134643 A1
(43) Pub. Date: Jun. 23, 2005

(54) Ink-jet printhead and method of manufacturing the same

(76) Inventors: Seo-hyun Cho, Seongnam-si (KR); Jae-cheol Lee, Hwaseong-gun (KR)

Correspondence Address: STANZIONE & KIM, LLP, 1740 N STREET, N.W., FIRST FLOOR, WASHINGTON, DC, 20036, US

(21) Appl. No.: 11/007,307

(22) Filed: Dec. 9, 2004

(30) Foreign Application Priority Data
Dec. 22, 2003 (KR) 2003-94416

(51) Int. Cl. B41J 2/135

(52) U.S. Cl. 347/44

(57) ABSTRACT

An ink-jet printhead and a method of manufacturing the same. The ink-jet printhead includes a substrate on which a heater to boil ink and a conductor to supply a current to the heater are formed, a chamber layer disposed on the substrate, the chamber layer defining an ink chamber containing the ink and being composed of at least polyimide, and a nozzle plate disposed on the chamber layer, the nozzle plate having nozzles through which the ink is ejected.

### CROSS-REFERENCE TO RELATED APPLICATIONS

This application claims the priority of Korean Patent Application No. 2003-94416, filed on Dec. 22, 2003, in the Korean Intellectual Property Office, the disclosure of which is incorporated herein in its entirety by reference.

### BACKGROUND OF THE INVENTION

1. Field of the Invention

The present general inventive concept relates to an ink-jet printhead and a method of manufacturing the same. More particularly, the present general inventive concept relates to an ink-jet printhead that has a high ink ejecting efficiency, and the method of manufacturing the ink-jet printhead.

2. Description of the Related Art

Generally, ink-jet printheads are devices that print a predetermined image in color or black and white by ejecting a small volume droplet of printing ink at a desired position on a recording sheet. Ink-jet printheads are usually categorized into two types according to an ink droplet ejection mechanism used. One type is a thermally driven ink-jet printhead in which a heat source is employed to form and expand bubbles in the ink to cause ink droplets to be ejected. The other type is a piezoelectrically driven ink-jet printhead in which a piezoelectric material is deformed to exert pressure on the ink to cause ink droplets to be ejected.

Hereinafter, the ink ejection mechanism in the thermally driven ink-jet printhead will be described in greater detail. When a pulse current flows through a heater composed of an electric resistance heating material, the heater generates heat and ink adjacent to the heater is heated to about 300° C., thereby boiling the ink. As the ink is boiled, bubbles are generated in the ink, and the bubbles expand and apply pressure to the ink in an ink chamber. As a result, the ink near a nozzle is ejected out of the ink chamber in droplets through the nozzle.

The thermal driving method includes a top-shooting method, a side-shooting method, and a back-shooting method depending on a growth direction of bubbles and an ejection direction of ink the droplets. In the top-shooting method, the bubble growth direction is the same as the direction in which the ink droplets are ejected. In the side-shooting method, the bubble growth direction is at a right angle to the direction in which the ink droplets are ejected. In the back-shooting method, the bubble growth direction is opposite to the direction in which the ink droplets are ejected.

An ink-jet printhead using the thermal driving method as described above should satisfy the following requirements. First, the manufacturing of the ink-jet printheads should be as simple as possible, costs of the manufacture of the ink-jet printheads should be low, and mass production of the ink-jet printheads should be easy. Second, in order to obtain a high-quality image, cross talks between adjacent nozzles should be suppressed while a distance between adjacent nozzles should be small. That is, in order to increase dots per inch DPI, a plurality of nozzles should be arranged with a high density. Third, in order to perform a high-speed printing operation, a period in which the ink chamber is refilled with ink after the ink is ejected out of the ink chamber should be as short as possible and the cooling of heated ink and a heater should be performed quickly to increase a driving frequency.

FIG. 1 is a partial perspective view illustrating a conventional ink-jet printhead using the top-shooting method, and FIG. 2 is a cross-sectional view illustrating the ink-jet printhead of FIG. 1.

Referring to FIG. 1, the ink-jet printhead includes a base plate 10 on which a plurality of material layers are deposited, a chamber layer 20 deposited on the base plate and defining an ink chamber 22, and a nozzle plate 30 deposited on the chamber layer 20. The ink chamber 22 is filled with ink, and a heater 13 (FIG. 2) to heat the ink and generate bubbles in the ink is installed under the ink chamber 22. Ink feedholes 24 form paths to supply the ink into the ink chamber 22, and are connected to an ink reservoir (not shown). A plurality of nozzles 32 through which the ink is ejected are formed in positions corresponding to each ink chamber 22.

Referring to FIG. 2, an insulating layer 12 to insulate a substrate 11 from the heater 13 is formed on the substrate 11 composed of silicon. The heater 13 is formed on the insulating layer 12 and heats ink in the ink chamber 22, thereby generating bubbles in the ink. The heater 13 is formed by vapor-depositing a thin film of tantalum nitride TaN or tantalum-aluminum TaAl on the insulating layer 12. A conductor 14 through which a current is supplied to the heater 13 is installed on the heater 13. The conductor 14 is formed of a metallic material having good conductivity.

A passivation layer 15 to passivate the heater 13 and the conductor 14 is formed on the heater 13 and the conductor 14. The passivation layer 15 prevents the heater 13 and conductor 14 from oxidizing and directly contacting the ink, and is composed of silicon nitride. An anti-cavitation layer 16, on which the ink chamber 22 is formed, is formed on the passivation layer 15.

The chamber layer 20 defining the ink chamber 22 is deposited on the base plate 10. The chamber layer 20 is generally composed of a material from the polyacrylate group. The nozzle plate 30 in which the nozzles 32 are formed is deposited on the chamber layer 20. A polyimide PI film processed by laser or a nickel Ni plate plated with gold Au is used as the nozzle plate 30.

In the configuration as described above, when heat is generated by the heater 13 and the ink chamber 22 is filled with the ink, bubbles are generated in the ink and expand near the heater 13, and the generated bubbles apply pressure to the ink in the ink chamber 22, thereby forcing the ink in the ink chamber 22 to be ejected in droplets through the nozzles 32.

However, in the ink-jet printhead as described above, the chamber layer 20 is constantly in contact with high temperature ink. Therefore, the material forming the chamber layer 20 may swell and the chamber layer 20 may be separated from the substrate 11 or the nozzle plate 30. When the separation between the layers occurs, ink ejection is largely effected, and the quality of printing decreases.

### SUMMARY OF THE INVENTION

The present general inventive concept provides an ink-jet printhead that has a high ink ejecting efficiency, and a method of manufacturing the ink-jet printhead.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an ink-jet printhead comprising: a substrate on which a heater to boil ink and a conductor to supply current to the heater are formed, a chamber layer disposed on the substrate, the chamber layer defining an ink chamber containing the ink and at least part of the chamber layer being composed of polyimide, and a nozzle plate disposed on the chamber layer, the nozzle plate having nozzles through which the ink is ejected.

The polyimide may be formed by imidizing polyamic acid at a predetermined temperature.

The predetermined temperature may be 240° C. to 400° C.

The polyimide may be formed when the nozzle plate is attached to an upper surface of the chamber layer.

A thickness of the chamber layer may be 10 μm to 100 μm.

An ink feedhole to supply the ink to the ink chamber may be formed in the substrate.

An insulating layer to insulate the substrate from the heater may be further included, the insulating layer being formed on the substrate.

A passivation layer to passivate the heater and the conductor may be further included, the passivation layer being formed above the heater and the conductor.

An anti-cavitation layer may be further included, the anti-cavitation being formed above the passivation layer.

The nozzle plate may be composed of one of polyimide and nickel Ni.

The foregoing and/or other aspects and advantages of the present general inventive concept may also be achieved by providing a method of manufacturing an ink-jet printhead comprising forming a heater and a conductor on a substrate, forming a chamber layer defining an ink chamber by coating polyamic acid on the substrate and patterning the polyamic acid, and attaching a nozzle plate having nozzles to an upper surface of the chamber layer at a predetermined temperature and converting at least part of the polyamic acid into polyimide.

The forming of the chamber layer may include forming a polyamic acid film by coating the polyamic acid on the substrate to a predetermined thickness and baking the polyamic acid, and patterning the polyamic acid film.

The polyamic acid may be coated on the upper surface of the substrate by spin coating.

The thickness of polyamic acid film may be 10 μm to 100 μm.

The polyamic acid film may be patterned using a photolithography process.

The polyamic acid film may be patterned using dry etching.

The nozzle plate may be attached to the upper surface of the chamber layer at a temperature of 240° C. to 400° C.

Forming an ink feedhole may be further included to supply the ink into the ink chamber in the substrate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a partial perspective view illustrating a conventional ink-jet printhead;

FIG. 2 is a cross-sectional view illustrating the ink-jet printhead of FIG. 1;

FIG. 3 is a top view schematically illustrating an ink-jet printhead according to an embodiment of the present general inventive concept;

FIG. 4 is a vertical cross-sectional view illustrating the ink-jet printhead of FIG. 3 taken along the line IV-IV′;

FIGS. 5A through 5F are cross-sectional views illustrating a method of manufacturing an ink-jet printhead according an the embodiment of the present general inventive concept;

FIG. 6A is a top view illustrating a sample to test adhesive strength; and

FIG. 6B is a side view illustrating a sample to test adhesive strength.

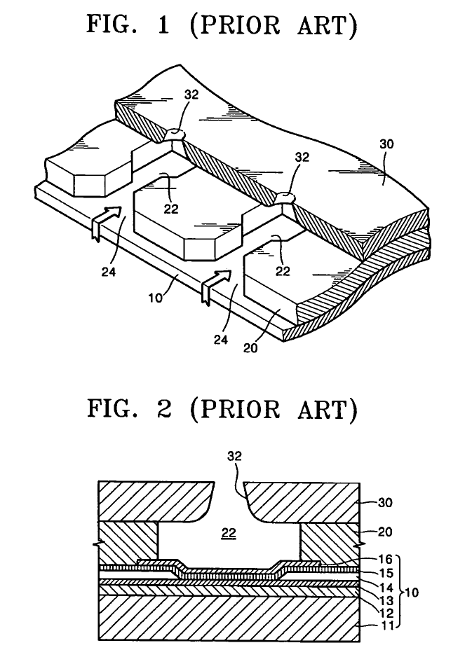

### DETAILED DESCRIPTION OF THE PREFERRED EMBODIMENTS

Reference will now be made in detail to the embodiment of the present general inventive concept, examples of which are illustrating in the accompanying drawings, wherein like reference numerals refer to like elements throughout. The embodiments are described below in order to explain the present general inventive concept, referring to the figures. In the figures, the thicknesses of layers and regions are exaggerated for clarity. It will also be understood that when a layer is referred to as being “on” another layer or substrate, it can be directly on the other layer or substrate, or intervening layers may also be present.

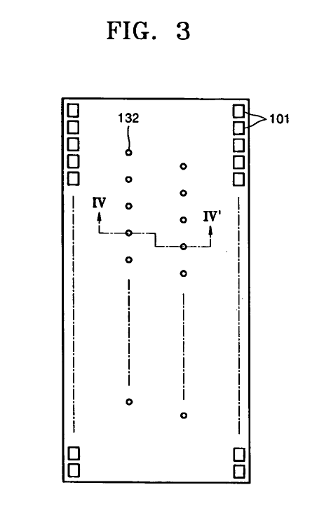

FIG. 3 is a top view schematically illustrating an ink-jet printhead using a top-shooting method according to an embodiment of the present general inventive concept. Referring to FIG. 3, nozzles 132 can be disposed in two rows on the surface of the ink-jet printhead, and bonding pads 101, on each of which a conductor can be bonded, can be disposed at both sides of the nozzles 132. The nozzles 132 may be disposed in one row, or in three or more rows to improve printing resolution.

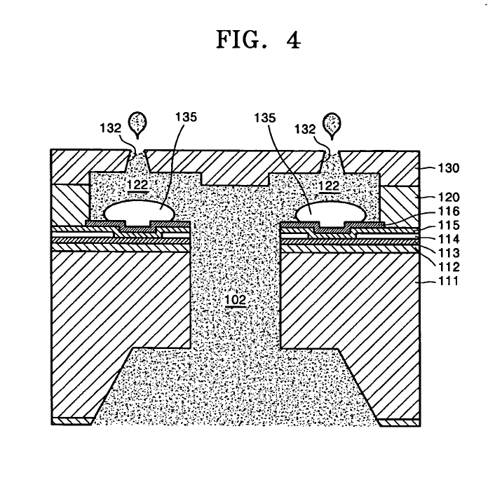

FIG. 4 is a cross-sectional view illustrating the ink-jet printhead of FIG. 3 taken along the line IV-IV′. Referring to FIG. 4, a chamber layer 120, and nozzle plate 130 can be sequentially deposited on a substrate 111. An ink feedhole 102 to supply ink to an ink chamber 122 can be formed in the substrate 111. The ink feedhole 102 can be connected to an ink reservoir (not shown). The chamber layer 120 defines the ink chamber 122 by forming sidewalls of the ink chamber 122. The nozzles 132, through which the ink is ejected out of the ink chamber 122, can be formed in the nozzle plate 130.

A silicon wafer generally used in the manufacturing of integrated circuits may be used as the substrate 111. An insulating layer 112 can be formed on the substrate 111. The insulating layer 112 functions not only as an insulation between the substrate 111 and a heater 113, but also as an adiabatic layer to prevent heat generated by the heater 113 from flowing toward the substrate 111. The insulating layer 112 may be a silicon oxide layer or a silicon nitride layer.

The heater 113 to boil the ink in the ink chamber 122 generates bubbles 135 in the ink and can be formed on the insulating layer 112. The heater 113 may be composed of an electric resistance heating material such as tantalum nitride TaN, tantalum-aluminium alloy TaAI, titanium nitride TiN, or tungsten silicide.

A conductor 114 to supply a current to the heater 113 can be formed on the heater 113. The conductor 114 can be patterned to expose part of the heater 113. The conductor may be composed of a metal having high conductivity such as aluminium, aluminium alloy, or tungsten.

A passivation layer 115 to passivate the heater 113 and the conductor 114 can be formed on the heater 113 and the conductor 114. The passivation layer prevents the heater 113 and conductor 114 from oxidizing and directly contacting the ink, and may be a silicon nitride layer.

An anti-cavitation layer 116, on which the ink chamber 122 can be formed, can be formed on the passivation layer 115. The anti-cavitation layer 116 prevents the heater 113 from damages due to a high pressure generated by the shrinking of the bubbles 135 in the ink in the ink chamber 122. The anti-cavitation layer 116 may be composed of tantalum Ta.

The chamber layer 120 can be formed on the above-described structure. The chamber layer 120 defines the ink chamber 122, in which the ink is filled. The chamber layer 120 forms sidewalls of the ink chamber 122. The thickness of the chamber layer 120 may be approximately 10 μm to 100 μm. The chamber layer 120 can be completely or partially composed of polyimide, which has a good swelling characteristic against ink. The polyimide can be formed by imidization of polyamic acid when the nozzle plate 130 is attached to an upper surface of the chamber layer 120 at a temperature of about 240° C. to 400° C.

The nozzle plate 130, on which the nozzles 132 can be formed, can be installed on the chamber layer 120. The nozzle plate 130 can be attached to the upper surface of the chamber layer 120 at a temperature of about 240° C. to 400° C., at which point the polyamic acid is imidized. At this time, the polyamic acid is imidized to form polyimide on the chamber layer 120. The nozzle plate 130 may be formed of a polyimide PI film processed by a laser or a nickel Ni plate plated with gold Au.

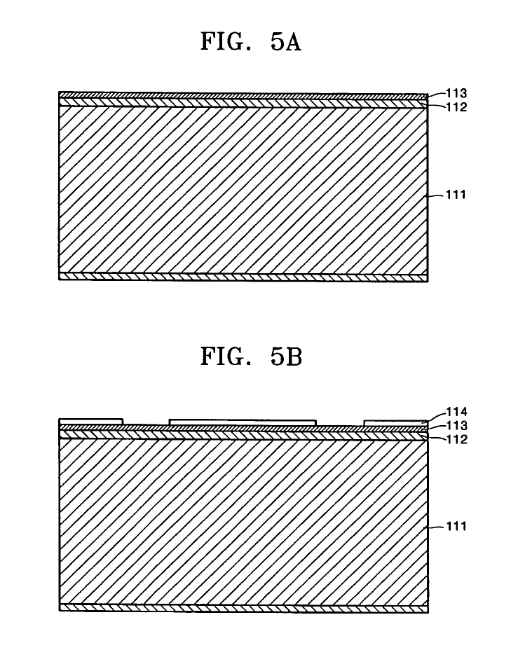

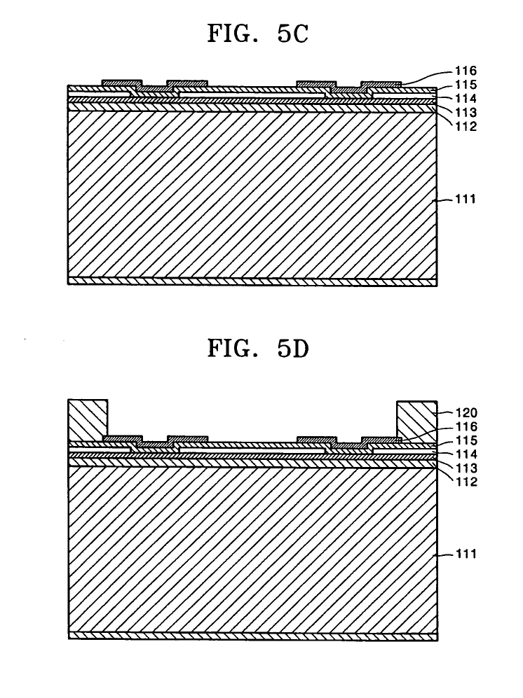

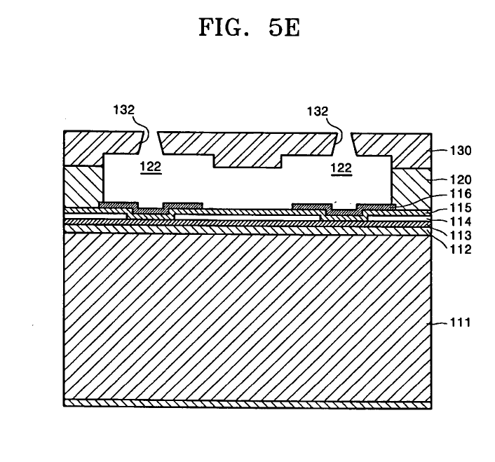

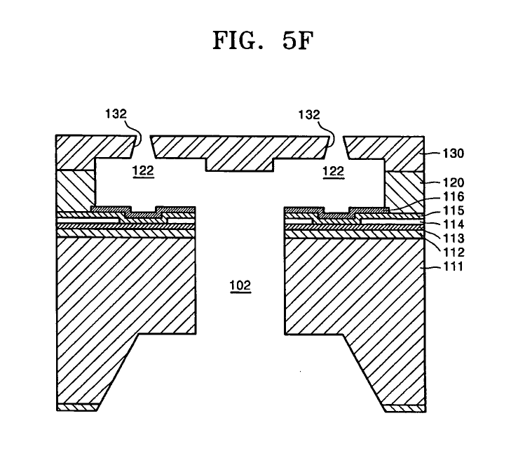

Hereinafter, a method of manufacturing the inkjet printhead according to an embodiment of the present general inventive concept will be described while referring to FIGS. 5A through 5F.

Referring to FIG. 5A, the insulating layer 112 can be formed on the substrate 111 and the heater 113 can be formed on the insulating layer 112. The substrate 111 can be formed by processing a silicon wafer to a thickness of about 400 μm to 650 μm. The silicon wafer, of which mass production is possible, is one of a type generally used in semiconductor devices. FIG. 5A illustrates a small portion of the silicon wafer, and several tens to hundreds of the ink-jet printheads according to an embodiment of the present general inventive concept may be manufactured on a single wafer.

The insulating layer 112 can be formed on a surface of the prepared silicon substrate 111. The insulating layer 112 may be formed by vapor depositing silicon oxide or silicon nitride on the surface of the substrate 111. The insulating layer 112 prevents heat energy generated by the heater 113 from flowing to the substrate 111.

Next, the heater 113 to boil the ink and generate bubbles 135 in the ink can be formed on the insulating layer 12. The heater 113 may be formed by vapor depositing an electric resistance heating material such as tantalum nitride TaN, tantalum-aluminium alloy TaAI, titanium nitride TiN, or tungsten silicide to a predetermined thickness.

Referring to FIG. 5B, the conductor 114 to apply the current to the heater 113 can be formed on the heater 113. The conductor 114 may be formed by vapor depositing a metal having high conductivity such as aluminium, an aluminium alloy, or tungsten on the heater 113 and patterning the deposited metal to expose a portion of the heater 113.

Referring to FIG. 5C, the passivation layer 115 can be formed on the heater 113 and the conductor 114, and the anti-cavitation layer 116 can be formed on the passivation layer 115. The passivation layer 115 may be formed by vapor depositing silicon nitride on the conductor 114 and the exposed portion of the heater 113. The passivation layer 115 prevents the heater 113 and the conductor 114 from oxidizing and directly contacting the ink. The anti-cavitation layer 116 may be formed by vapor depositing tantalum Ta on the surface of the passivation layer 115 and patterning the tantalum Ta. The anti-cavitation layer 116 prevents the heater 113 from damage due to the high pressure generated by the shrinking of the bubbles in the ink in the ink chamber 122.

Referring to FIG. 5D, the chamber layer 120 defining the ink chamber 122 can be formed on the passivation layer 115 and the anti-cavitation layer 116.

First, polyamic acid can be spin coated on the surface of the structure illustrated in FIG. 5C to a predetermined thickness and then baked. The polyamic acid may be converted to polyimide by imidizing at a temperature of 240° C. to 400° C. The polyamic acid film may be formed to a thickness of about 10 μm to 100 μm.

Next, the chamber layer 120 defining the ink chamber 122 can be formed by patterning the polyamic acid film to a predetermined shape. In this case, the polyamic acid film may be patterned by one of two methods. One method includes patterning the polyamic acid including a photosensitive additive by photolithography using a mask. The other method includes patterning the polyamic acid film by dry etching.

Referring to FIG. 5E, the nozzle plate 130, on which the nozzles 132 can be formed, can be attached to the upper surface of the chamber layer 120. The nozzle plate 130 can be attached to the upper surface of the chamber layer 120 at the temperature of 240° C. to 400° C. at which the polyacmic acid is imidized. The nozzle plate 130 may be composed of a polyimide film processed by a laser or a nickel Ni plate plated with gold Au. When the nozzle plate 130 is attached to the upper surface of the chamber layer 120, a part or the entire polyamic acid forming the chamber layer 120 of FIG. 5D is imidized and converted into polyimide having a good swelling characteristic against ink.

Referring to FIG. 5F, the ink feedhole 102 to supply the ink to the ink chamber 122 may be formed in the substrate 111. The ink feedhole 102 may be formed by installing an etching mask (not shown) on a rear portion of the substrate 111 and etching the rear portion of the substrate 111 exposed by the etching mask to perforate the substrate 111. In this case, the etching of the substrate 111 may be performed by dry etching using plasma or wet etching using an etchant as tetramethyl ammonium hidroxide TMAH or KOH.

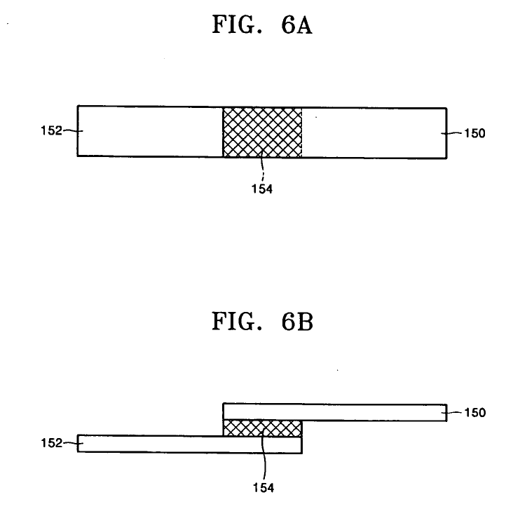

FIGS. 6A and 6B are a top view and a side view, respectively, illustrating a sample to test the adhesive strength between the inter-layers. Referring to FIGS. 6A and 6B, the sample has a single over-lap joint that attaches an upper and lower film 150 and 152 to an intermediate film 154. In this case, the length and width of the upper and lower films 150 and 152 are respectively 60 mm and 5 mm, and the length and width of the intermediate film 154 are respectively 20 mm and 5 mm. Polyimide films can be used as the upper and lower films 150 and 152.

The sample as described above was manufactured in three types and the adhesive strength of each of the samples was measured. In the first sample, the intermediate film 154 was a polyacrylate film, and was manufactured with an attachment pressure of 15 atm, at an attachment temperature of 220° C., and for an attachment period of 30 minutes. The tensile strength of the first sample was 0.57 MPa. In the second sample, the intermediate film 154 was a polyamic acid film, and was manufactured with an attachment pressure of 15 atm, at an attachment temperature of 220° C., and for an attachment period of 30 minutes. The tensile strength of the second sample was 0.33 MPa. In the third sample, the intermediate film 154 was the polyamic acid film, and was manufactured with an attachment pressure of 15 atm, at an attachment temperature of 250° C., and for an attachment period of 30 minutes. The tensile strength of the third sample was 0.61 MPa.

Considering these results, when the intermediate film 154 was a polyacrylate film which was used to form the chamber layer of a conventional ink-jet printhead, the tensile strength of the sample was 0.57 MPa. But if the intermediate film contacts ink at a high temperature, the separation of the inter-layer occurs due to the swelling of the intermediate film 154. When the intermediate film 154 was a polyamic acid film and an attachment was made under the same conditions, the tensile strength was 0.33 MPa, which is weaker than the first example.

However, when the intermediate film 154 is a polyamic acid film and an attachment temperature is 250° C., as in the ink-jet printhead according to an embodiment of the present general inventive concept, the tensile strength is 0.61 MPa. A part or the entire polyamic acid is imidized and converted into polyimide at an attachment temperature of 250° C. Comparing this with conventional polyacrylate, polyamic acid, or polyimide, has a good characteristic against ink.

As described above, according to embodiments of the present general inventive concept, the chamber layer 120 defining an ink chamber 122 can be composed of polyimide having a good characteristic against ink. The polyimide is formed by imidization of polyamic acid at a predetermined temperature. Thus the chamber layer 120 does not separate from the substrate 111 or the nozzle plate 130 and an ejecting efficiency of the ink is improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An ink-jet printhead comprising:
a substrate on which a heater to boil ink and a conductor to supply a current to the heater are formed;
a chamber layer disposed on the substrate, the chamber layer defining an ink chamber containing the ink, and at least part of the chamber layer being composed of polyimide; and
a nozzle plate disposed on the chamber layer, the nozzle plate having nozzles through which the ink is ejected.

2. The ink-jet printhead of claim 1, wherein the polyimide is formed by imidizing polyamic acid at a predetermined temperature.

3. The ink-jet printhead of claim 2, wherein the predetermined temperature is substantially 240° C. to 400° C.

4. The ink-jet printhead of claim 2, wherein the polyimide is formed when the nozzle plate is attached to an upper surface of the chamber layer.

5. The ink-jet printhead of claim 1, wherein a thickness of the chamber layer is substantially 10 μm to 100 μm.

6. The ink-jet printhead of claim 1, wherein an ink feedhole to supply the ink to the ink chamber is formed in the substrate.

7. The ink-jet printhead of claim 1, further comprising an insulating layer to insulate the substrate from the heater, the insulating layer being formed below the heater on the substrate.

8. The ink-jet printhead of claim 7, wherein the insulating layer is disposed between the substrate and the heater.

9. The ink-jet printhead of claim 1, further comprising a passivation layer to passivate the heater and the conductor, the passivation layer being formed above the heater and the conductor.

10. The ink-jet printhead of claim 9, further comprising an anti-cavitation layer formed above the passivation layer.

11. The ink-jet printhead of claim 1, wherein the nozzle plate is composed of one selected from the group consisting of polyimide and nickel Ni.

12. An ink-jet printhead comprising:
a sub layer formed on a substrate to heat ink to be ejected out of an ink chamber;
a chamber layer formed above the sub layer and having at least a part thereof composed of polyimide, and forming side walls of the ink chamber; and
a nozzle layer attached to the chamber layer having nozzles to eject droplets of the ink.

13. The ink-jet printhead of claim 12, wherein the sub layer comprises:
a insulation layer deposited on the substrate to insulate the substrate;
a heater deposited on the insulation layer to heat the ink;
a conductor deposited on a part of the heater to supply a current to the heater;
a passivation layer deposited on the conductor and the heater to prevent the heater and the conductor from oxidizing and directly contacting the ink; and
an anti-cavitation layer deposited on the passivation layer to prevent damages to the heater.

14. The ink-jet printhead of claim 13, wherein the chamber layer is formed on the passivation layer and the anti-cavitation layer.

15. The ink-jet printhead of claim 12, wherein the polyimide is formed by imidizing polyamic acid at a predetermined temperature.

16. The ink-jet printhead of claim 15, wherein the predetermined temperature is substantially 240° C. to 400° C.

17. The ink-jet printhead of claim 15, wherein the polyimide is formed when the nozzle plate is attached to the chamber layer.

18. The ink-jet printhead of claim 12, wherein a thickness of the chamber layer is substantially 10 μm to 100 μm.

19. The ink-jet printhead of claim 12, wherein an ink feedhole to supply the ink to the ink chamber is formed in the substrate.

20. A method of manufacturing an ink-jet printhead comprising;
forming a heater and a conductor on a substrate;
forming a chamber layer defining an ink chamber by coating polyamic acid on the substrate and patterning the polyamic acid; and
attaching a nozzle plate having nozzles to an upper surface of the chamber layer at a predetermined temperature and converting at least part of the polyamic acid into polyimide.

21. The method of claim 20, wherein the forming the chamber layer comprises:
forming a polyamic acid film by coating the polyamic acid on the substrate to a predetermined thickness and baking the polyamic acid; and
patterning the polyamic acid film.

22. The method of claim 21, wherein the polyamic acid is coated on an upper surface of the substrate by spin coating.

23. The method of claim 21, wherein the thickness of the polyamic acid film is substantially 10 μm to 100 μm.

24. The method of claim 21, wherein the polyamic acid film is patterned using a photolithography process.

25. The method of claim 21, wherein the polyamic acid film is patterned using dry etching.

26. The method of claim 20, wherein the nozzle plate is attached to an upper surface of the chamber layer at a temperature of substantially 240° C. to 400° C.

27. The method of claim 20, further comprising forming an ink feedhole to supply ink into the ink chamber in the substrate.

28. The method of claim 20, further comprising forming an insulating layer on the substrate before the forming of the heater and the conductor.

29. The method of claim 20, further comprising forming a passivation layer above the heater and the conductor.

30. The method of claim 29, further comprising forming an anti-cavitation layer above the passivation layer.

31. The method of claim 20, wherein the forming of the heater and the conductor comprise:
forming the heater by vapor depositing an electric resistance heating material; and
forming the conductor by vapor depositing a metal having a high conductivity.

32. A method of manufacturing an ink-jet printhead comprising:
forming a sub layer above a substrate that heats ink to be ejected out of an ink chamber;
forming a chamber layer above the sub layer defining walls of the ink chamber;
attaching a nozzle plate having nozzles on an upper surface of the chamber layer.

33. The method of claim 32, wherein the forming of the sublayer comprises:
forming an insulation layer on the substrate that insulates the substrate;
depositing a heater on the insulation layer that heats the ink;
depositing a conductor on a part of the heater that supplies a current to the heater;
depositing a passivation layer on the conductor and the heater that prevents the heater and the conductor from oxidizing and directly contacting the ink; and
depositing an anti-cavitation layer on the passivation layer that prevents damages to the heater.

34. The method of claim 33, wherein the chamber layer is formed on the passivation layer and the anti-cavitation layer.

35. The method of claim 32, wherein the chamber layer includes at least a polyimide material.

36. The method of claim 35, wherein the polyimide is formed by imidizing polyamic acid at a predetermined temperature.

37. The method of claim 36, wherein the polyimide is formed when the nozzle plate is attached to the chamber layer.
